(19) United States
(12) Patent Application Publication
(10) Pub. No.: US 2008/0227322 A1
(43) Pub. Date: Sep. 18, 2008

(54) High Voltage Wet Mateable Electrical Connector

(75) Inventor: Joseph Allan Nicholson, Foxfield (GB)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 12/063,004

(22) PCT Filed: Aug. 3, 2006
(86) PCT No.: PCT/GB06/02882

§ 371 Date: Feb. 21, 2008

(30) Foreign Application Priority Data
Aug. 26, 2005 (GB) 0517496.6

(51) Int. Cl. H01R 13/523

(52) U.S. Cl. 439/271

(57) ABSTRACT

An electrical connector for use in subsea applications, the connector comprising a receptacle component comprising a fluted, insulated male contact pin, and a plug component comprising a contact assembly. On engagement of the receptacle component and plug component in use, a watertight electrical connection is formed between the male contact pin and the contact assembly. The receptacle component further comprises an isolation tube substantially surrounding the insulated male contact pin over at least part of its length and containing oil therein, in use.

The present invention relates to a wet mateable electrical connector for use in providing high voltage power to systems in deepwater or offshore subsea equipment. Examples of such systems are submersible pumps or motors for separation and power distribution systems.

Hydrocarbons which are in the form of heavy crude oil are difficult to extract through conventional means, other than through electrical submersible pumps (ESP's). There is a need for high horse power motors (1.5-2.0 MW) for subsea wellheads to extract such hydrocarbons. Such systems require electrical connection through a subsea wellhead in shallow or deep water (approximately 5-3000 m), where space for the connection through the wellhead is restricted. Further, wellhead electrical connectors have to cope with high differential pressures up to about 5000 psi and temperatures up to about 120° C.

High horsepower pump systems are more economical to run in deepwater and it is desirable to increase the system voltages from around 4 kVac to 8 kVac. Additionally, the need for subsea power connectors is increasing and even higher system voltages of up to 36 kV will be required for long distance power distribution.

Wet mateable connectors are known where the electrical connection is made in an oil filled environment and where the openings for the contacts are sealed by means of a spring energised stopper or shuttle pin. Insulation blocks with labyrinth seals or flexible walled diaphragms are known to be used. It is also possible to use sliding contacts to allow the connector to achieve a tolerance to linear engagement, required in wellhead applications due to the tolerance stack-ups on the wellhead parts and lock-down mechanisms. However, such connector systems are lacking when it comes to high voltage connection systems because their insulation around the male contact pin is exposed to seawater. There is therefore a need for a wet mateable connector which meets the requirements for deep water usage and is reliable at these high voltage levels. According to the present invention there is provided an electrical connector for use in subsea applications, the connector comprising: a receptacle component comprising a fluted, insulated male contact pin and a plug component comprising a contact assembly; wherein, on engagement of the receptacle component and plug component in use, a watertight electrical connection is formed between the male contact pin and the contact assembly; wherein the receptacle component further comprises an isolation tube substantially surrounding the insulated male contact over at least part of its length and containing oil therein, in use.

The isolation tube may be made from metal to provide a non-permeable barrier or from an insulating material such as polyetheretherketone (PEEK), glass reinforced plastic (GRP) or a ceramic material to provide additional insulation to the male contacts.

The receptacle component may further comprise an oil filled wiper system which feeds, in use, the male contacts with insulation oil such as dielectric oil. The wiper system is filled with insulation oil and when the wiper system is displaced by the plug component on engaging of the receptacle component and plug connector in use, the oil slides down the male contacts and isolation tubes. At all times an oil reservoir is provided to maintain the insulation and protection to the male contact. The flutes in the insulation around the male contact and the isolation tube improve oil circulation and exchange between the male contact and the wiper system.

The connector may further comprise a first cone seal arranged to seal around an engaging end of the insulated male contact pin and a second cone seal arranged to seal around an engaging end of the contact assembly, wherein a seal is formed between the first and second cone seals on engaging of the plug and receptacle components in use. The cone seals effectively form seals between the mating connector components to provide additional insulation during connection. Additionally this extends the voltage field around each contact to form a smooth electrical field pattern and lower voltage gradient through the seal interfaces, thereby reducing tendency for electrical tracking.

The connector of the present invention has a highly managed level of insulation. The male contacts are environmentally protected and the connector can provide a sealed insulation system or closed system approach. The electrical insulation is critical to the connector performance and a closed system approach prevents the interaction of fluids such as glycols, seawater and hydraulic oils and marine organisms which can affect a connector's performance significantly over the life of the connection system, which may be twenty years or more.

The receptacle component may comprise three male contact pins and isolation tubes as defined above and a substantially triangular diaphragm surrounding the isolation tubes. The triangular shape of the diaphragm provides a large volume to accommodate displacement of oil during engagement of the receptacle component with the plug component.

Additionally, the plug component may further comprise a release mechanism arranged to align, in use, the male contact pin and the contact assembly prior to full engaging of the receptacle and plug components. The release mechanism may comprise a shuttle member moveable within the contact assembly and a release means; wherein on engaging of the plug component and receptacle component in use, the shuttle member is arranged to release the release means to allow full engagement of the plug component and receptacle component.

Examples of the present invention will now be described with reference to the accompanying drawings, in which:

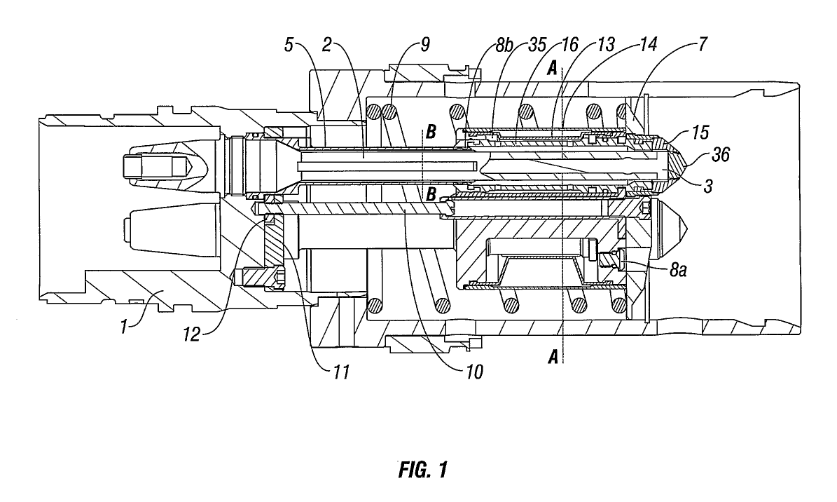

FIG. 1 is a longitudinal cross-sectional view of an example receptacle component according to the present invention;

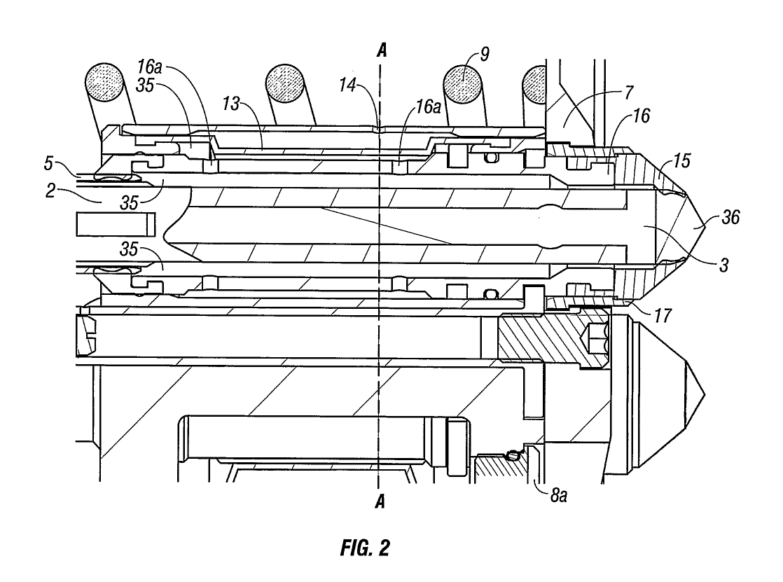

FIG. 2 is an enlarged view of the receptacle component in FIG. 1;

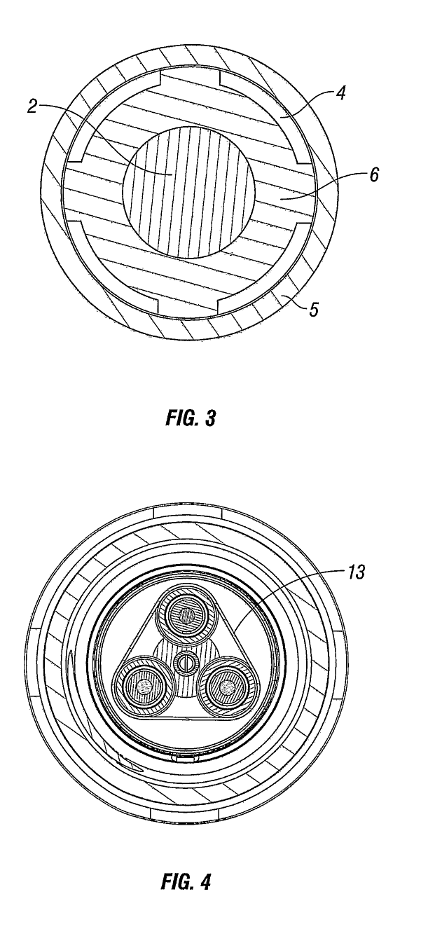

FIG. 3 is a section of the receptacle component shown in FIG. 1 taken at B-B;

FIG. 4 is a section of the receptacle component shown in FIG. 1 taken at A-A;

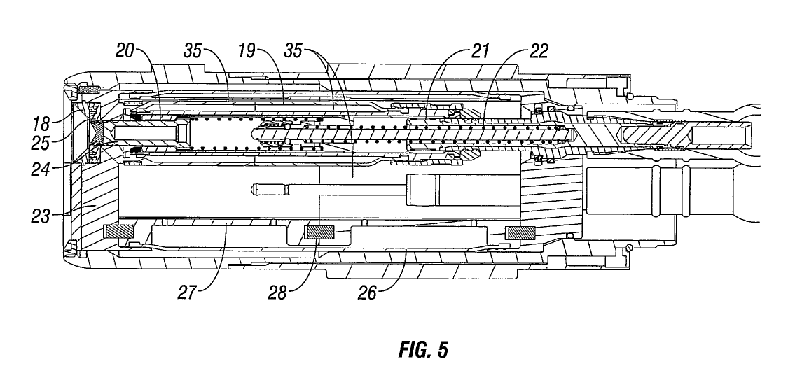

FIG. 5 is a longitudinal cross-sectional view of an example plug component according to the present invention;

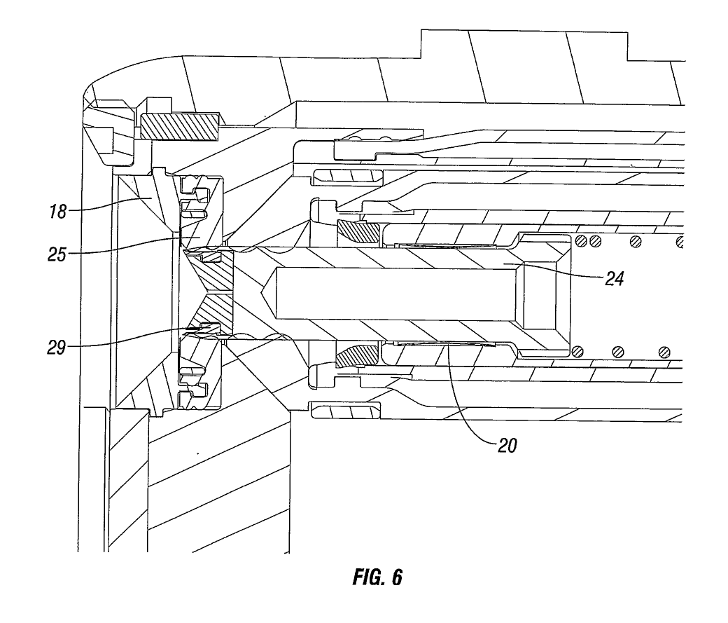

FIG. 6 is a more detailed view of the engaging end of the plug component in FIG. 5;

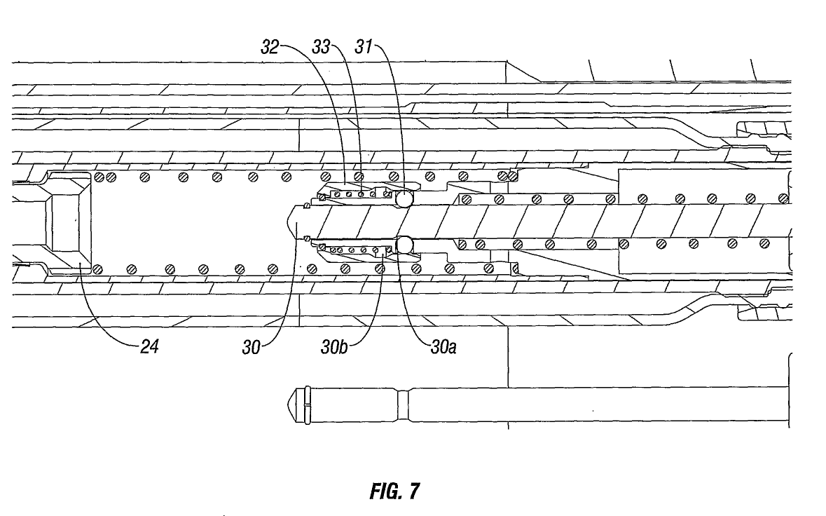

FIG. 7 is an enlarged view of the release mechanism of the plug component of FIG. 5;

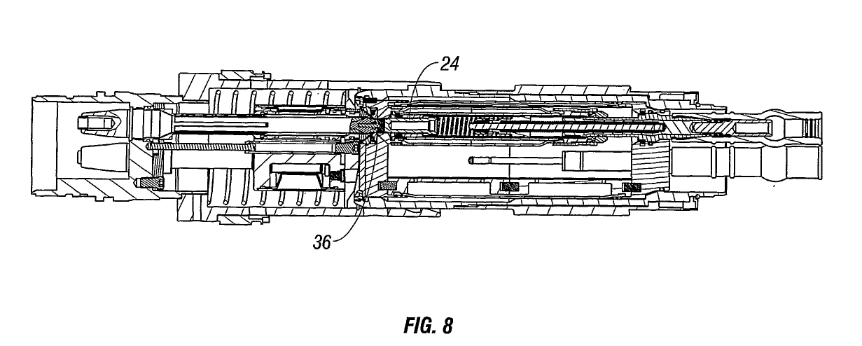

FIG. 8 is a longitudinal cross-sectional view of the mating receptacle component of FIG. 1 and plug component of FIG. 5, when the receptacle wiper seals engage the plug component insulators;

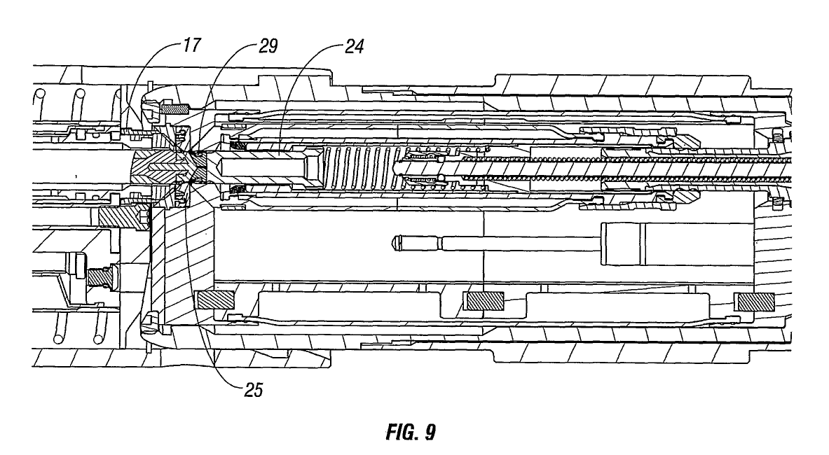

FIG. 9 is an enlarged view of the engagement stage shown in FIG. 8;

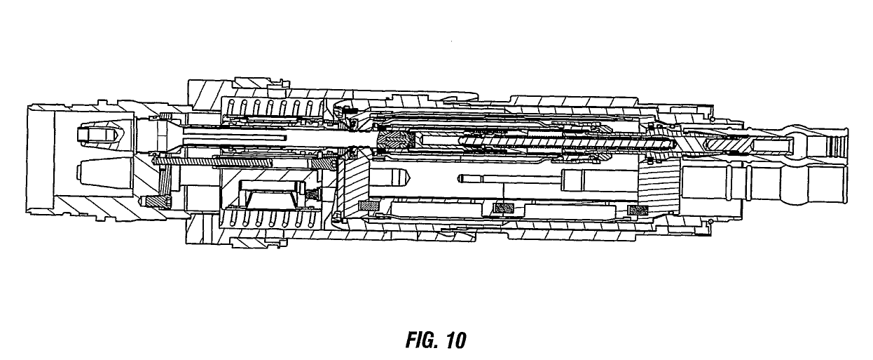

FIG. 10 is a longitudinal cross-sectional view of the mating receptacle component of FIG. 1 and plug component of FIG. 5, when the sliding contact pin in the contact assembly of the plug component is released through the release mechanism;

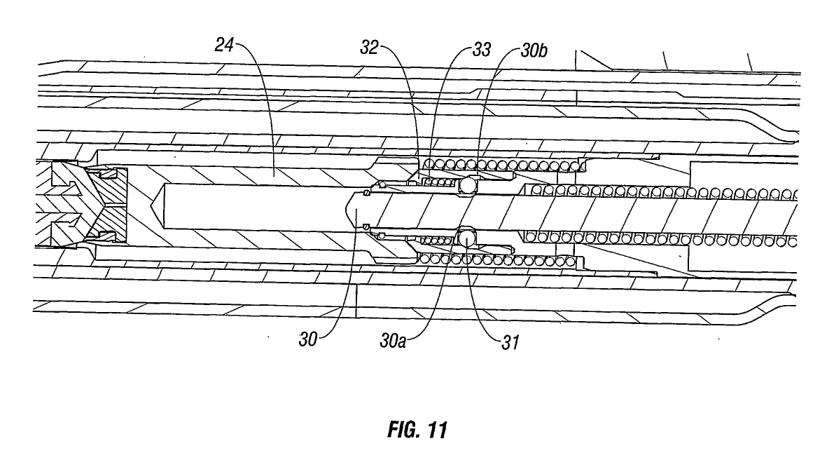

FIG. 11 is an enlarged view of the release mechanism in the position shown in FIG. 10; and

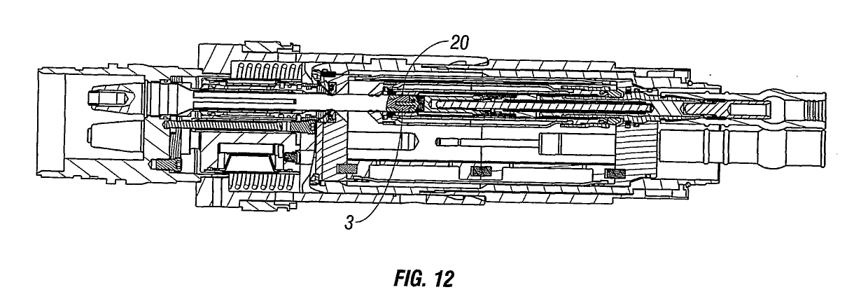

FIG. 12 is a longitudinal cross-sectional view of the mated connector.

A receptacle component of a connector according the present invention will now be described with reference to FIGS. 1 to 4. FIG. 1 and FIG. 2 show a receptacle component with three male pins and a spring energised wiper assembly 7 filled with oil 35. The body 1 houses a male contact pin 2 which is insulated along its length with thermoplastic insulation such as PEEK and has a contact band 3. The insulated male contact 2 has a central metallic core made from a material that allows high current transmission, such as a high conductivity copper alloy. FIG. 3, which is a section through B-B of FIG. 1, shows the insulation 6 around the male pin 2. There are external flutes 4 in the insulation 6 to allow oil passage between the pin 2 and a surrounding isolation tube 5. The isolation tube 5 can be metallic or plastic to provide additional insulation and extends part of the way along the pin 2.

The wiper assembly 7 is filled with dielectric oil 35 through a port 8a under vacuum to remove air. Front cone seals 15 seal onto the male contacts 2 and rear lip seals 8b seal on to the isolation tubes 5. The wiper assembly 7 is energised through a spring 9 and retained by a pin 10 which can be adjusted through a plate 11 and a backing nut 12 to set its position.

The receptacle further comprises a pressure balancing diaphragm 13. Because of the difference in diameter between the contact pin 2 and the isolation tube 5, the diaphragm 13 has to allow for expansion when displaced. To accommodate this, the diaphragm 13 is triangular in shape, as shown in FIG. 4, which is a section through A-A of FIG. 1. A port 14 pressure balances the wiper oil 35 by allowing seawater depth pressure to act on the outward facing surface of the diaphragm 13.

Referring to FIG. 2, the front cone seals 15 are comprised by a front cone seal assembly comprising cone seals 15. Each cone seal 15 is made of a low permittivity elastomer with high dielectric strength and is mounted on the end of an insulating tube 16 which has holes 16a therein for the free passage of oil. The cone seals 15 are held in place by clips 17 which also provide an abutment to mating concave insulation cones 18 on a plug component (see FIG. 5 and FIG. 6), setting the seal engagement height.

FIG. 5 shows a plug component which houses three oil filled sliding contact pin assemblies 19 comprising sliding contact pins with front contact bands 20 and rear sliding contact bands 21. A spring 22 energises the sliding contact pin assemblies 19 against an insulation plate 23 at the opening end of the plug component. A shuffle pin 24 closes the opening through a wiper seal 25 to retain oil inside the connector. The contacts 20, 21 are enclosed in an oil filled pressure balanced environment using a diaphragm 26 and support insulators 27. The insulators 27 are dowelled together for orientation purposes using dowels 28.

As shown in FIG. 6, shuttle pin seals 29 serve to hold and retain water and debris at the interface of the male pin 2 and the shuttle pin 24 when they are mated together. The insulation cones 18 mentioned above provide additional insulation and to seal with the cone seals 15 of the receptacle component on engagement of the connector.

A release mechanism is shown in FIG. 7, which allows a two stage engagement of the connector contacts. This is to align the plug contact and receptacle component and set the contact position before sliding contact action can take place. Because the contact friction is high, this mechanism is designed to overcome the limitations of a pure spring setting force, which may not be positive enough to position the contacts accurately. A central spring support rod 30 has undercuts 30a to accommodate balls 31 and together with a release collar 32 with a spring 33 provides a release mechanism for the sliding contact when the shuttle pin 24 is displaced by the male pin 2 during engagement of the connector.

FIGS. 8 to 12 show the mating sequence of the plug and receptacle. The first stage (not shown) is the initial engagement. At this point, the plug nose 36 of the plug component engages the receptacle component, becoming diametrically aligned and oriented.

The second stage is shown in FIG. 8 and FIG. 9. The receptacle wiper seal 15 engages the plug component and the clips 17 abut the plug cone seals 18 to set seal engagement. The shuttle pin 24 engages the tip of the male pin 2 tip and the shuttle pin seal 29 traps debris and water.

The third stage is shown in FIG. 10 and FIG. 11. The plug and receptacle engage to the point where the sliding contact pin is released through the release mechanism. The end of the shuttle pin 24 strikes the corresponding end of the collar 32 moving it backwards (to the right as shown in FIG. 11), so allowing the balls 31 to be released from the undercut 30a by movement into the groove 30b, which in turn allows movement of the contact pin forward, displacing the sliding contact pin assemblies 19. The plug and receptacle then become fully engaged, as shown in FIG. 12.

What is claimed is:

1. An electrical connector for use in subsea applications, the connector comprising:
a receptacle component comprising a fluted, insulated male contact pin; and
a plug component comprising a contact assembly;
wherein, on engagement of the receptacle component and plug component in use, a watertight electrical connection is formed between the male contact pin and the contact assembly; and
wherein the receptacle component further comprises an isolation tube substantially surrounding the insulated male contact pin over at least part of its length and containing oil therein, in use.

2. A connector according to claim 1, wherein the isolation tube is made from metal.

3. A connector according to claim 1, wherein the isolation tube is made from an insulating material.

4. A connector according to claim 1, wherein the receptacle component further comprises an oil filled wiper system arranged to feed, in use, the male contact pin with oil.

5. A connector according to claim 1, further comprising a first cone seal arranged to seal around an engaging end of the insulated male contact pin and a second cone seal arranged to seal around an engaging end of the contact assembly, wherein a seal is formed between the first and second cone seals on engaging of the plug and receptacle components in use.

6. A connector according to claim 1, wherein the receptacle component comprises three male contact pins and associated isolation tubes and a substantially triangular diaphragm surrounding the isolation tubes.

7. A connector according to claim 1, wherein the plug component further comprises a release mechanism arranged to align, in use, the male contact pin and the contact assembly prior to full engaging of the receptacle and plug components.

8. A connector according to claim 7, wherein the release mechanism comprises a shuttle member moveable within the contact assembly and a release means, wherein on engaging of the plug component and receptacle component in use, the shuttle member is arranged to release the release means.
